(19) United States
(12) Patent Application Publication
(10) Pub. No.: US 2014/0344141 A1
(43) Pub. Date: Nov. 20, 2014

(54) AUTOMATICALLY TRIGGERED ADAPTIVE MONEY ALLOCATION BY FINANCIAL INSTITUTION

(71) Applicant: Curtis C. Cook, Burlingame, CA (US)

(72) Inventor: Curtis C. Cook, Burlingame, CA (US)

(21) Appl. No.: 13/908,449

(22) Filed: Jun. 3, 2013

Related U.S. Application Data
(60) Provisional application No. 61/825,420, filed on May 20, 2013.

(51) Int. Cl. G06Q 20/10

(52) U.S. Cl. CPC G06Q 20/10
USPC 705/39

(57) ABSTRACT

In a typical scenario, a bank provides the following on-line service to their customers (users), implemented as a software program in a server associated with the bank. The server is able to access allocation files that are programmable via the internet by a user. The user specifies rules in the allocation files identifying one or more percentages associated with respective ones of the user's secondary accounts to be applied to future deposits to the user's primary account (such as a checking account). Examples of secondary accounts may include a tax account, a retirement account, etc. The user also specifies one or more priorities associated with the respective secondary accounts. When a new deposit is made to the primary account, or on a pre-set periodic basis, the rules are automatically applied by the server to transfer the pre-set percentages of the deposits to the respective secondary accounts in the priority order.

### CROSS-REFERENCE TO RELATED APPLICATIONS

This application is based, in part, on U.S. provisional application Ser. No. 61/825,420, filed May 20, 2013, entitled, A System and Method to Monitor All of One's Bank and Financial Accounts with Adaptive Money Transfers Triggered by Financial Transactions, by the present inventor and incorporated herein by reference.

### FIELD OF THE INVENTION

This invention relates to financial transactions and, in particular, to an adaptive method of allocating pre-specified percentages or amounts of deposited funds into various pre-specified accounts based on certain pre-specified priorities.

### BACKGROUND

Conventional on-line resources offered by financial institutions, such as banks, allow an account owner to authorize/schedule automatic transfers from, for example, a checking account. The owner may use the on-line resources to schedule to pay bills with the funds in the checking account. The bills may even be paid automatically by the bank after receipt by the creditors.

In such a scheduled bill-pay system, the transfers from the owner's account are automatically made to the creditors' accounts independently of any deposits made by the owner to the account. The bills are typically not paid prior to the creditor sending the bill to the bank, and the payment is for the specified amount of the bill.

The owner may also manually transfer money on-line from one account to another of the owner's accounts, even if the account is in another bank.

In all such cases, the timing of the transfer of funds (e.g., to creditors or to the owner's other accounts) is unrelated to the timing of a deposit of money into the owner's account.

In some cases, when a check or other monetary transfer is deposited into the owner's account (e.g., the owner is paid by a wire transfer for services provided), the owner may then manually schedule to allocate some of the deposited funds to one or more other accounts, such as accounts reserved for business expenses, vacations, college, taxes, retirement, etc. Thus, the owner must be vigilant to consistently perform the allocations to meet the owner's own financial goals. Present on-line tools offered by financial institutions do not allow the owner to pre-specify such allocations for each new deposit.

In summary, the prior art techniques for the automatic transfer of funds are performed based on scheduled events other than a deposit event and are not adaptive.

Accordingly, what is needed is an on-line tool to allow such pre-specified automatic/adaptive transfers to designated accounts for each withdraw or deposit made to the owner's primary account. Such an on-line feature offered by financial institutions will allow the user to consistently apply a set of rules for each deposit/withdraw that will result in the user being more financially responsible.

### SUMMARY

In one embodiment, it is assumed that an owner of a checking account at a bank receives his pay every two weeks via an on-line deposit by his employer into the checking account.

At some time prior to a deposit, the owner accesses a web site provided by the bank that allows the owner to specify a percentage of the deposits that are to be allocated to other accounts. The accounts may have priorities, where the higher priority accounts are paid into before the lower priority accounts.

For example, the owner of the checking account may initially set up a retirement account, a vacation account, a college account, and a tax account in the same bank (the first bank) as the checking account or in a different bank or financial institution. The owner then uses the inventive on-line feature provided by the first bank to specify a certain percentage of each paycheck to be allocated to the various accounts and the priorities of the allocations. The owner specifies the account number, routing number, and any required password to make the transfers.

For example, the first priority allocation for a new deposit may be 25% to the tax account, the second priority allocation may be 10% to the retirement account, the third priority allocation may be 10% to the college account, and the fourth priority allocation may be 10% to the vacation account. The remainder remains in the checking account. The owner may specify a minimum or maximum allocation. In the event there are insufficient funds deposited to satisfy all criteria of the transfers, the higher priority transfers are satisfied first.

In another embodiment, the adaptive and automatic transfer of the specified percentages is performed on a periodic basis on the sum of all deposits made since the last transfer time, rather on a deposit-by-deposit basis. The owner specifies the rules for the transfers. The owner may also specify a rule that a certain minimum amount must remain in the checking account, thus, in some cases, preventing some lower priority transfers.

The above scenario is likely to be a common scenario; however, for small business owners that have more complex business needs, the allocations may include allocations to employees' pensions, allocations to business improvements, etc.

Many other examples of rules are described herein.

The above allocations may be performed in conjunction with conventional scheduled bill pay systems, where the allocations have priorities relative to certain bill paying priorities. For example, the owner may specify that allocations of the deposits may only be applied after certain bills are paid (e.g., only after the mortgage bill is paid on a monthly basis).

By using the above-described on-line feature offered by a bank or other financial institution, the user will be more financially responsible since the pre-set allocations force the user to maintain a consistent financial strategy.

Other embodiments are described in the detailed description.

### BRIEF DESCRIPTION OF THE DRAWINGS

FIG. 1 illustrates a system in accordance with one embodiment of the invention.

FIG. 2 is a flowchart showing steps used in one embodiment of the invention.

FIG. 3 is a sample table in a report automatically prepared for the user after allocations are performed on two deposits.

### DETAILED DESCRIPTION

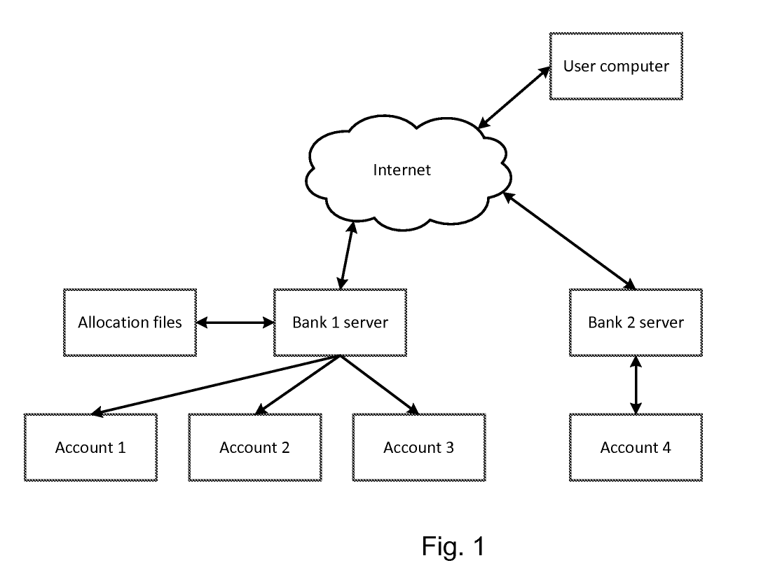

FIG. 1 illustrates a system that implements one embodiment of the present invention.

A user accesses a Bank 1 server via the internet using the user's computer. The log-in to the Bank 1 server may be in a conventional way, such as accessing the Bank 1 website, entering a user account number and password, and navigating through one or more menus.

The Bank 1 has implemented the present invention as a software module that augments the Bank 1's existing on-line bill pay system. Therefore, the present invention does not interfere with any existing feature offered by the Bank 1. The software module (stored in a memory) is identified as the Allocation files.

It is assumed that the user has a savings or checking Account 1 with the Bank 1, and the Account 1 is where the user has designated his deposits to be posted. The deposits may be physical checks received by the Bank 1, on-line deposits such a direct deposits by the user's employer, wire transfers, etc. Deposits are usually posted by a bank in the evening and show up in the user's account report the next morning.

It is also assumed the user has opened any number of other accounts in Bank 1. For simplicity, only two other accounts, Account 2 and Account 3, are shown that the user has designated for a specific purpose. For example, Account 2 may be designated as tax account from which to pay anticipate taxes, and Account 3 may be an expense account that the user uses for paying business expenses.

It is also assumed that the user has opened an Account 4 in a separate Bank 2 (or other financial institution), such as for a college fund or other purpose. Other accounts may be a tax account, a vacation account, a home improvement account, etc.

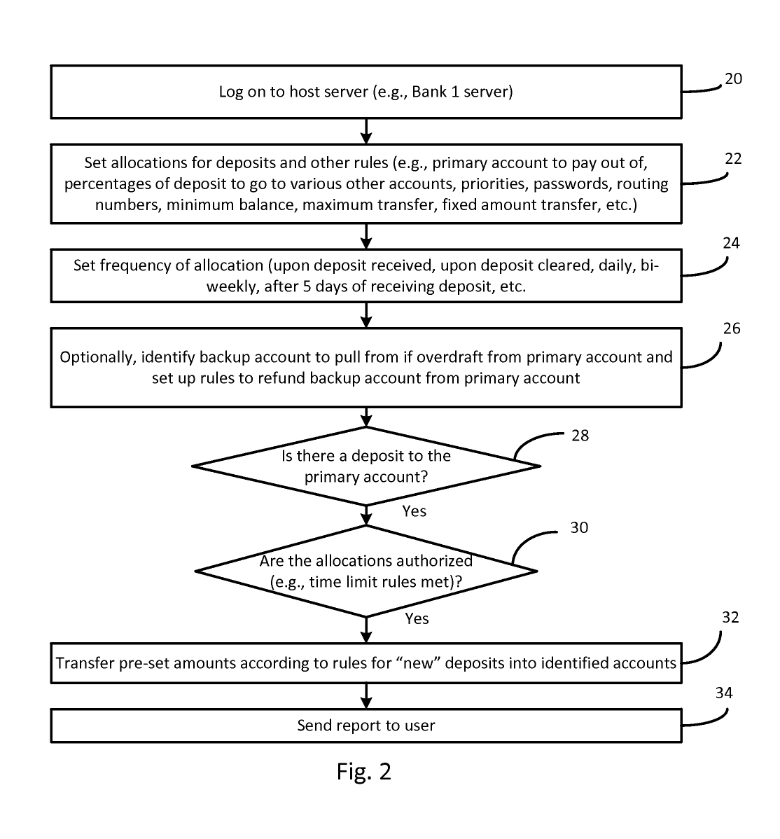

Referring to the flowchart of FIG. 2, in step 20, the user initially logs into the Bank 1 server, or any other server which supports the present invention and can access the user's various accounts. The server need not be physically located at the Bank 1 and may even be in another country or not controlled by the Bank 1. However, the Bank 1 server is associated with the Bank 1 so far as the server controls aspects of the transfer of funds deposited into the user's primary account serviced by the Bank 1.

In step 22, the user navigates into the Allocation files to set up the various allocations and rules that are to be applied to each deposit into the Account 1 or are to be applied on a periodic basis. The allocations may be applied to any credit posted to Account 1.

In one embodiment, the user is led through a series of menus, walking the user through the process of setting up the allocations and rules by presenting the user with various blank boxes to fill in and instructions. The user may be prompted to identify the primary account from which to make the allocations (e.g., Account 1), the percentages of the deposited amounts to go to various other accounts (e.g., Accounts 2-4), the priorities of the allocations, the bank routing numbers, the account numbers, the passwords of the various accounts to enable access by the transferring system, the minimum or maximum amounts for each transfer, fixed amount transfers, etc.

Note that, since the allocations are made in a priority order, the first priority allocation deducts from the full deposited amount, and the lower priority allocations deduct their respective percentages to the remainder of the deposit.

In step 24, the user sets the frequency of the allocation, such as daily (which may perform the allocation from the sum of all deposits posted the evening before), after five days (to ensure clearance), bi-weekly, etc. In one embodiment, the allocations are irrespective of the source of the deposit. In another embodiment, the user may specify different allocations (including zero) for different sources of the deposits.

In step 26, the user may identify a certain backup account in the event the calculated balance in Account 1 (after the proposed allocations) falls below a certain minimum threshold, where the backup account temporarily transfers money into the Account 1 to fund the allocations. The Account 1 may be instructed to automatically transfer the “loaned” money back to the backup account after subsequent deposits to the Account 1.

In one example, the user may specify that each day the following rules be applied for any deposits posted to the Account 1 the previous evening:
a. Transfer 25% to the tax Account 2;
b. Transfer 20% to the business expense Account 3;
c. Transfer 10% to the college fund Account 4;
d. Limit the allocations for b and c to a maximum of $1000 each;
e. Transfer a fixed amount to Account X;
f. Limit the allocations to 75% of the deposited amount;
g. Allocate the funds in accordance with the following Account priorities, while applying the rules after each transfer: 1) Account 2; 2) Account 3; 3) Account 4.
h. Block the allocations if the Account 1 falls below a certain threshold;
i. Transfer (or pull) funds from the specified backup account into the Account 1 in the event the Account 1 balance falls below a certain minimum threshold, and later refund the backup account from Account 1 to a certain minimum threshold level after subsequent deposits into Account 1.
j. Block the allocations for deposits below a certain threshold limit.

Other possible scenarios for the user's allocations and rules are envisioned.

Once the allocations and rules have been set by the user, the Bank 1 server applies the rules to the various deposits made to Account 1.

In step 28, the Bank 1 server determines if there is a deposit to the primary account (Account 1).

If so, then in step 30, the Bank 1 server determines whether the allocations are authorized by applying the rules set by the user, such as performing the allocations on a daily basis.

If so, then in step 32, the Bank 1 server initiates the transfer of the percentages of the newly deposited funds in accordance with the user's rules to the various accounts (e.g., Accounts 2-4). Multiple servers may be involved in the transfer.

In step 34, the Bank 1 server sends a report (or makes one available on-line) to the user identifying the various transfers and the balances.

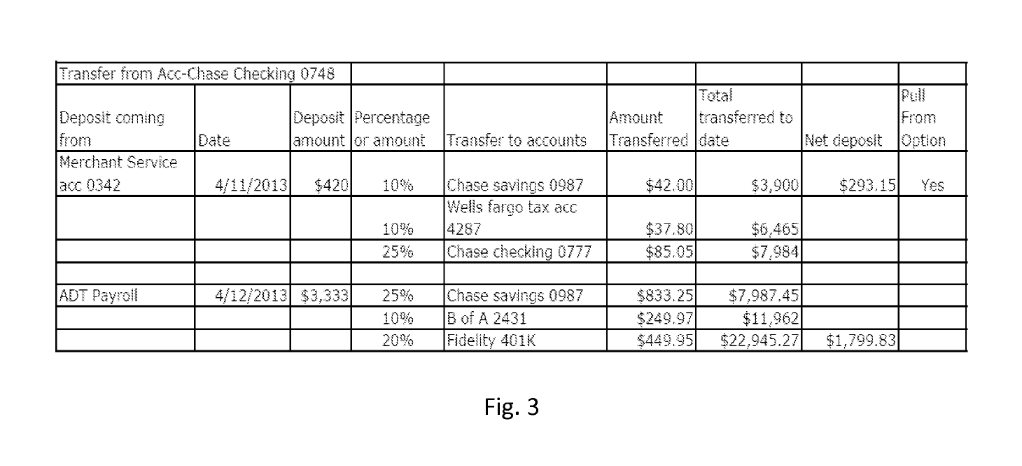

FIG. 3 illustrates a sample report for the user.

In the example of FIG. 3, the report identifies the primary account (Account 1) from where the transfers are made from, which in this case is the user's Acc-Chase Checking account 0748. The report identifies the source of the various deposits (subsequent to the previous allocation event), the date, the initial deposited amount, the percentage allocations from the deposit, the accounts to where the allocated percentages were transferred, the amount transferred, the total amount transferred to that account to date, the net deposit into the primary account after allocations have been made, and a “pull from option” identifying that the option to pull funds from a backup account has been set.

The report may also identify the remaining balance in the primary account.

As seen from the report, the user had pre-programmed allocation percentages and destination accounts for the deposit coming from the Merchant Service account 0342 that are different from the allocation percentages and destination accounts for the deposit coming from the ADT Payroll account (the user's employer's direct deposit account). Accordingly, the user may treat a payroll deposit differently from any other deposit using the present system.

The invention is not limited to being implemented by financial institutions but may be implemented by business managers or financial managers and others who receive deposits. In one example, the business manager may control one or more accounts for a client and deposits received entered by the manager into a computer are automatically allocated to the client's accounts. Some of the accounts may be associated with a financial institution. The manager may pre-select the allocations based on inputs by the client.

The present invention enforces discipline on the users, resulting in more control of the user's finances and increased financial responsibility. Many other scenarios are envisioned.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

1. A system for allocating monetary amounts from deposits in a primary account to one or more secondary accounts comprising:
a server;
the server being able to access allocation files that are programmable via the internet by a user;
a primary account, associated with a first entity, into which deposits are made from one or more sources; and
allocation files stored in a memory accessible by the server, the allocation files containing rules programmed by the user via the internet, the rules comprising at least the following:
one or more percentages associated with respective one or more secondary accounts to be applied to future deposits made to the primary account, the one or more secondary accounts being under control of the user and being associated with the user;
one or more priorities associated with the respective one or more of the secondary accounts,
wherein the server is programmed to automatically apply the one or more percentages and the one or more priorities to amounts later deposited in the primary account and initiate transfer of those percentages of the deposits to the respective one or more secondary accounts in accordance with rules pre-programmed by the user, and
wherein the server is programmed to deduct from the primary account a predetermined first percentage, associated with a certain priority secondary account, in accordance with the rules, then, after the first percentage has been subtracted from the primary account, deduct from the remaining primary account a predetermined second percentage, associated with a lower priority secondary account, in accordance with the rules.

2. The system of claim 1 wherein the first entity is a first financial institution.

3. The system of claim 1 wherein the first financial institution is a bank.

4. The system of claim 1 further comprising the rules designating a fixed amount from the deposits to be allocated to the one or more of the secondary accounts.

5. The system of claim 1 wherein the rules are applied on a deposit by deposit basis.

6. The system of claim 1 wherein the rules are applied on a periodic basis to a sum of a plurality of deposits made subsequent to a previous application of the rules.

7. The system of claim 1 wherein the rules identify specific sources of deposits to which the rules apply, wherein the rules are not applied to certain other sources of the deposits.

8. The system of claim 1 wherein the primary account is the user's checking account.

9. The system of claim 1 wherein the primary account is the user's savings account.

10. The system of claim 1 wherein the allocation files identify account numbers and other information for the one or more secondary accounts required for transferring monetary funds from the primary account into the one or more secondary accounts.

11. The system of claim 1 wherein the rules identify at least one of a minimum amount or a maximum amount that may be transferred to the one or more secondary accounts.

12. The system of claim 1 wherein the rules identify a minimum threshold level of the primary account, such that any transfer to the one or more secondary accounts that would cause the primary account to be below the threshold level is blocked.

13. The system of claim 1 wherein the rules identify a backup account from which funds are transferred into the primary account to prevent the primary account from going below a threshold amount.

14. The system of claim 1 wherein the server is further programmed to generate a report identifying to the user transfers made in accordance with the rules.

15. An automated method for transferring funds between a primary account and one or more secondary accounts comprising:
providing a server, the server being able to access allocation files that are programmable via the internet by a user;
providing a primary account, associated with a first entity, for receiving deposits from one or more sources; and
applying rules stored in the allocation files, contained in a memory accessible by the server, the rules being programmed by the user via the internet, the rules identifying at least the following:
one or more percentages associated with respective one or more secondary accounts to be applied to future deposits to the primary account, the one or more secondary accounts being under control of the user and being associated with the user;
one or more priorities associated with the respective one or more of the secondary accounts,
wherein the server automatically applies the one or more percentages and the one or more priorities to amounts later deposited in the primary account and initiates the transfer of those percentages of the deposits to the respective one or more secondary accounts in accordance with rules pre-programmed by the user, and
wherein the server automatically deducts from the primary account a predetermined first percentage, associated with a certain priority secondary account, in accordance with the rules, then, after the first percentage has been subtracted from the primary account, deducts from the remaining primary account a predetermined second percentage, associated with a lower priority secondary account, in accordance with the rules.

16. The method of claim 15 wherein the first entity is a first financial institution.

17. The method of claim 15 wherein the rules are applied on a deposit by deposit basis.

18. The method of claim 15 wherein the rules are applied on a periodic basis to a sum of a plurality of deposits made subsequent to a previous application of the rules.

19. The method of claim 15 wherein the rules identify specific sources of deposits to which the rules apply, wherein the rules are not applied to certain other sources of the deposits.

20. The method of claim 15 wherein the rules identify at least one of a minimum amount or a maximum amount that may be transferred to the one or more secondary accounts.

21. The method of claim 15 wherein the rules identify a minimum threshold level of the primary account, such that any transfer to the one or more secondary accounts that would cause the primary account to be below the threshold level is blocked.

22. The method of claim 15 wherein the rules identify a backup account from which funds are transferred into the primary account to prevent the primary account from going below a threshold amount.

23. The method of claim 15 wherein the server is further programmed to generate a report identifying to the user transfers made in accordance with the rules, the method further comprising generating the report.
